(19) United States
(12) Patent Application Publication
(10) Pub. No.: US 2006/0210717 A1
(43) Pub. Date: Sep. 21, 2006

(54) Ornament fabrication method

(76) Inventor: Ching-Tang Chang, Changhua (TW)

Correspondence Address: BACON & THOMAS, PLLC, 625 SLATERS LANE, FOURTH FLOOR, ALEXANDRIA, VA, 22314, US

(21) Appl. No.: 11/082,848

(22) Filed: Mar. 18, 2005

(51) Int. Cl. B05D 7/00; B05D 7/22

(52) U.S. Cl. 427/421.1; 427/402; 427/230

(57) ABSTRACT

An ornament fabrication method in which the inner wall of a hollow ornament is first entirely spray-coated with an adhesive and then a reflective material is applied by spraying onto the inner wall of the hollow ornament. Following the adhesion of the reflective material, loose reflective material is poured out to complete the spray-coating process

### BACKGROUND OF THE INVENTION

1) Field of the Invention

The invention herein relates to an ornament fabrication method, specifically a fabrication method utilized to produce various holiday ornaments in the form of suspendable spheres that achieves fabrication simplicity and higher quality in that the ornaments are not subject to exterior damage. Furthermore, the present invention reduces production cost, minimizes small particulate environmental pollution, and prevents health hazards.

2) Description of the Prior Art

Prior art ornament fabrication methods, referring to FIG. 1 and FIG. 2, typically consist of spray-coating an adhesive 11 onto the exterior surface of a suspendable sphere 1, reflective particles 12 are then sprayed onto the exterior layer, and following a lengthy period of natural air drying, the ornament is packaged, shipped, and marketed.

However, since the prior art method requires an extended period of natural air drying, much precious time as well as labor cost are expended. Additionally, since the reflective particles 12 are attached to the suspendable sphere 1 by means of a thin layer of adhesive 11, the reflective particles 12 are readily dislodged by minor vibration and impact, which adversely affects external appearance quality (as shown in FIG. 3).

Furthermore, as the reflective particles 12 are attached to the suspendable sphere 1 only by means of the thin layer of adhesive 11, if children play unattended with such ornaments, the reflective particles 12 may get into their eyes or the entire ornament may be perceived as an edible object and placed into the mouth, posing a serious danger to physical health.

Therefore, the applicant of the invention herein, fully knowledgeable of the prior art shortcomings and based on many years of experience gained while engaged in the relevant fields, conducted continuous research and development that culminated in the ornament fabrication method of the invention herein, which is submitted in application for patent rights.

### SUMMARY OF THE INVENTION

The primary objective of the invention herein is to provide an ornament fabrication method in which since an adhesive is first directly spray-coated onto the interior wall of a hollow ornament, reflective material can then be applied by spraying onto the interior wall of the hollow ornament, and following the adhesion of the reflective material, loose reflective material is poured out to complete the spray-coating process.

Another objective of the invention herein is to provide an ornament fabrication method in which since the adhesive and the reflective material are attached to the interior wall of the hollow ornament, no hazard to physical health results when young children orally play with them as edible objects and environmental pollution problems are prevented.

Yet another objective of the invention herein is to provide an ornament fabrication method in which the loose reflective material poured out during the fabrication process can be recycled and utilized again.

For purposes of review and reference, the brief description of the drawings below are followed by the detailed description of the preferred embodiments of the invention herein.

### BRIEF DESCRIPTION OF THE DRAWINGS

FIG. 1 is an isometric drawing of the prior art fabrication process.

FIG. 2 is an isometric drawing of the prior art fabrication process.

FIG. 3 is an isometric drawing of the prior art product shortcoming.

FIG. 4 is an isometric drawing of the fabrication process of the invention herein (1)

FIG. 5 is a cross-sectional drawing of the fabrication process of the invention herein (2).

FIG. 6 is a cross-sectional drawing of the fabrication process of the invention herein (3).

FIG. 7 is a cross-sectional drawing of the fabrication process of the invention herein (4).

FIG. 8 is a cross-sectional drawing of the fabrication process of the invention herein (5).

FIG. 9 is a cross-sectional drawing of the invention herein at the completion of fabrication.

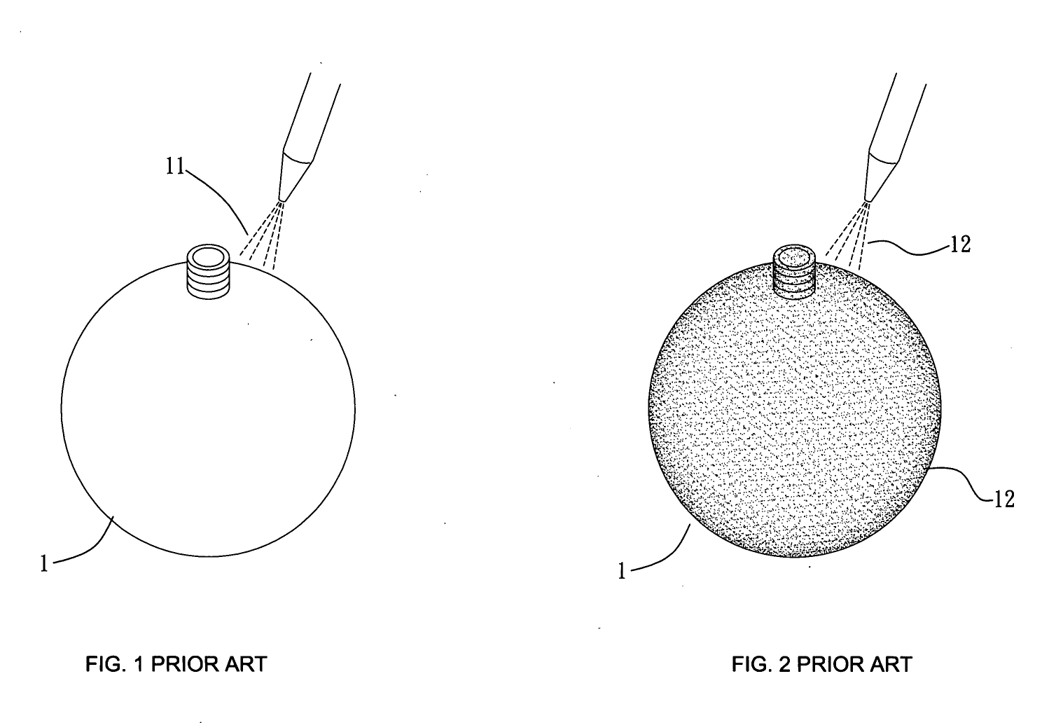

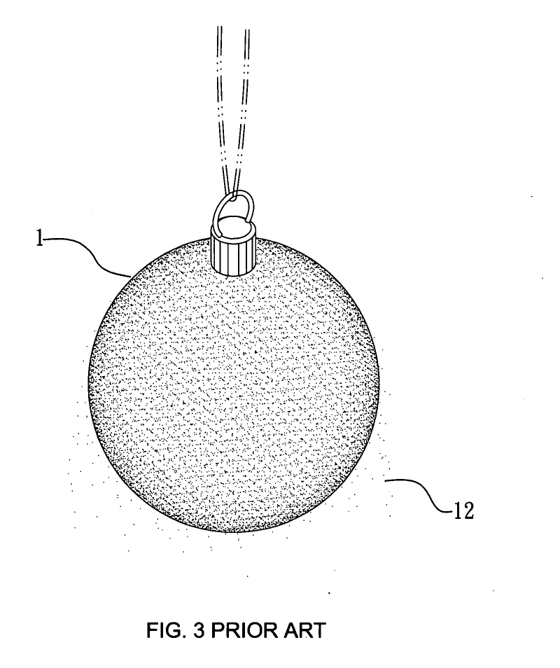

### DETAILED DESCRIPTION OF THE PREFERRED EMBODIMENTS

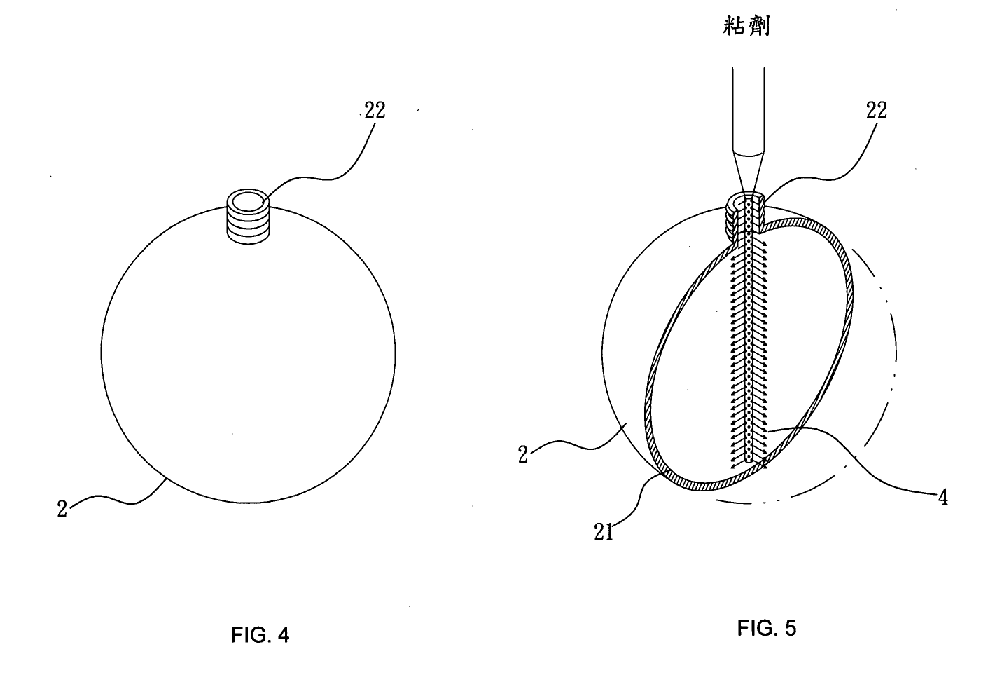

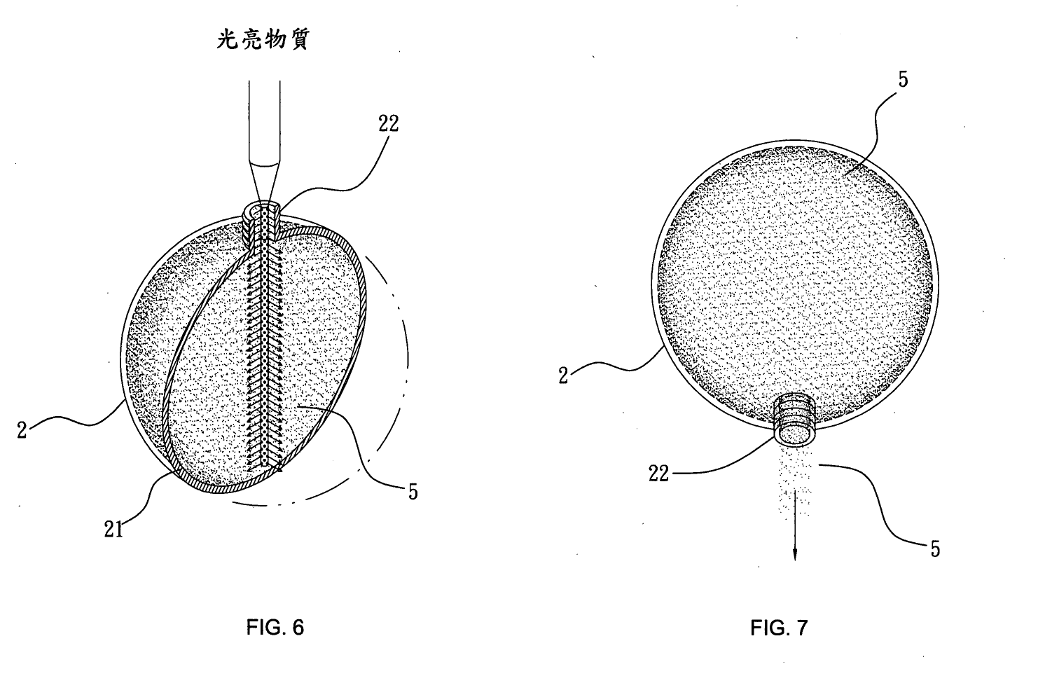

Referring to FIG. 4 and FIG. 5, the invention herein consists of an ornament 2 that can be fabricated in various three-dimensional exterior shapes and, furthermore, is a hollow structure having an interior wall 21 with a threaded hole section 22 disposed at an area of the ornament 2 which provides for the fastening of a screw-on cap 3 at the final stage of the fabrication process to facilitate the coupling of a dangling ring 31 to the screw-on cap 3, thereby providing for overall physical suspension such as hanging on a Christmas tree; the significant aspect of the invention herein is that the interior wall 21 of the hollow ornament 2 is first spray-coated with an adhesive 4, reflective material 5 is then applied by spraying onto the interior wall 21 of the hollow ornament 2, and the reflective material 5 is allowed to become attached to the adhesive 4 (as shown in FIG. 6), examples of the reflective material including glitter, nap, glowing granules, and luminous particles, etc.

Thereafter, loose reflective material 5 is poured out (as shown in FIG. 7) to complete the coating process.

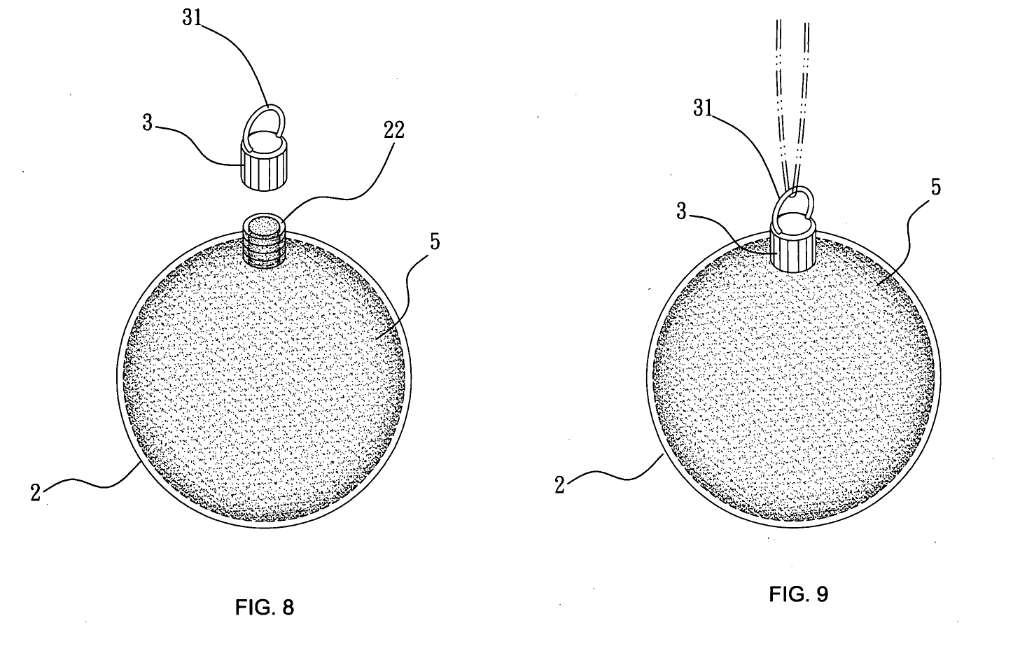

Finally, referring to FIG. 8 and FIG. 9, the dangling ring 3 is coupled to the screw-on cap 3 fastened into the threaded hole section 22 provided for the installation of the screw-on cap 3 onto the ornament 2, thereby enabling its suspension.

In summation of the foregoing section, since the present invention is of an advanced structural arrangement and possesses improved as well as original content, while also capable of achieving industrial utility and progressiveness and, therefore, meets the requirements stipulated by the patent law, the invention herein is lawfully submitted to the patent bureau for review and the granting of the commensurate patent rights.

However, the said disclosure only presents the most preferred embodiments of the invention herein which shall not be construed as a limitation on the scope of the present invention; furthermore, all modifications and adaptations based on the patent application claims of the invention herein shall remained protected under the patent claims of the present invention.

1. An ornament fabrication method in which the interior wall of a hollow ornament is first spray-coated with an adhesive, reflective material is then applied by spraying onto the interior wall of the said hollow ornament, and following the adhesion of the reflective material, the loose said reflective material is poured out to complete the spray-coating process.
